(19) United States
(12) Patent Application Publication
(10) Pub. No.: US 2024/0191704 A1
(43) Pub. Date: Jun. 13, 2024

(54) SMA ACTUATOR ASSEMBLY

(71) Applicant: CAMBRIDGE MECHATRONICS LIMITED, Cambridge, Cambridgeshire (GB)

(72) Inventors: Andrew Benjamin Simpson Brown, Cambridge (GB); Joshua Carr, Cambridge (GB)

(21) Appl. No.: 18/286,188

(22) PCT Filed: Apr. 14, 2022
(86) PCT No.: PCT/GB2022/050954

§ 371 Date: Oct. 9, 2023

(30) Foreign Application Priority Data
Apr. 14, 2021 (GB) 2105295.6
Oct. 22, 2021 (GB) 2115237.6

(51) Int. Cl. F03G 7/06

(52) U.S. Cl. CPC F03G 7/06143; F03G 7/0636; F03G 7/064; F03G 7/066; F05B 2260/20; F05B 2270/804

(57) ABSTRACT

An actuator assembly comprises a support structure (6), a movable part (5) movable relative to the support structure, at least one shape memory alloy (SMA) wire (2) connected between the support structure and the movable part via wire attach components and arranged, on contraction, to drive movement of the movable part and a control circuit configured to apply drive signals to the at least one SMA wire so as to drive movement of the movable part relative to the support structure between predetermined positions in a repeated pattern; wherein the length of the at least one SMA wire extending between respective wire attach components is less than 5 mm.

### FIELD

The present invention relates to the use of SMA (shape memory alloy) wires to provide positional control of a movable part relative to a support structure on which the movable part is supported.

### BACKGROUND

There are a variety of types of apparatus in which it is desired to provide positional control of a movable part relative to a support structure. SMA actuator wire is advantageous as an actuator in such an apparatus, in particular due to its high energy density which means that the SMA actuator required to apply a given force is of relatively small size.

One type of apparatus in which SMA actuator wire is known for use as an actuator is a camera, particularly a miniature camera. Some documents disclosing examples of this are as follows.

WO2013/175197 discloses an SMA actuation apparatus that moves a movable element relative to a support structure in two orthogonal directions using a total of four SMA actuator wires each connected at their ends between the movable element and the support structure and extending perpendicular to the primary axis. None of the SMA actuator wires are collinear, but the SMA actuator wires have an arrangement in which they are capable of being selectively driven to move the movable element relative to the support structure to any position in said range of movement without applying any net torque to the movable element in the plane of the two orthogonal directions around the primary axis. Accordingly, it is possible to drive movement whilst balancing the forces to limit torque around the primary axis.

WO2011/104518 discloses an SMA actuation apparatus that uses SMA actuator wires to move a movable element supported on a support structure, for example to provide optical image stabilisation. Eight SMA actuator wires are arranged inclined with respect to a notional primary axis with a pair of the SMA actuator wires on each of four sides around the primary axis. The SMA actuators are connected so that on contraction two groups of four SMA actuator wires provide a force with a component in opposite directions along the primary axis, so that the groups are capable of providing movement along the primary axis. The SMA actuator wires of each group have 2-fold rotational symmetry about the primary axis, so that there are SMA actuator wires opposing each other that are capable of providing lateral movement or tilting.

WO2019/243849 discloses a shape memory alloy actuation apparatus comprising a support structure and a movable element. A helical bearing arrangement supporting the movable element on the support structure guides helical movement of the movable element with respect to the support structure around a helical axis. At least one shape memory alloy actuator wire is connected between the support structure and the movable element in, or at an acute angle to, a plane normal to the helical axis, so as to drive rotation of the movable element around the helical axis which the helical bearing arrangement converts into said helical movement.

WO2019/243842 discloses an SMA actuation apparatus comprising a support structure and a movable element supported thereon by a suspension system that supports the movable element on the support structure and guides movement of the movable element along a movement axis. Two closely spaced lengths of SMA wire that are close to parallel and inclined at the same acute angle with respect to a plane normal to the movement axis are connected to the support structure and to the movable element so as to apply respective forces to the movable element with respective components parallel to the movement axis that are in opposite directions. The two lengths of shape memory alloy wire apply a couple to the movable element perpendicular to the movement axis and the suspension system includes a pair of flexures or bearings that resist the resultant couple applied to the movable element by the lengths of SMA wire.

In cameras of the type disclosed in the above documents, in use the movable element is in general moved continuously across its range of movement, in accordance with the instantaneous demand, for example the demand for focusing in the case of autofocus or the demand of image stabilisation in the case of optical image stabilisation (OIS). The SMA wire may typically have a length of order 10 mm to provide the desired stroke. However, the present invention is concerned with applications where the movable element is desired to be moved with relatively short stroke, but with a movement cycle in which the movable element is moved relatively rapidly and then held in position. Non-limitative examples of such applications include super-resolution cameras, three dimensional (3D) sensing systems and wobulation of a displayed (e.g. projected) image.

### SUMMARY

According to a first aspect of the present invention, there is provided an actuator assembly comprising a support structure, a movable part movable relative to the support structure, at least one shape memory alloy (SMA) wire connected between the support structure and the movable part via wire attach components (e.g. crimps or welds) and arranged, on contraction, to drive movement of the movable part and a control circuit configured to apply drive signals to the at least one SMA wire so as to drive movement of the movable part relative to the support structure between predetermined positions in a repeated pattern; wherein the length of the at least one SMA wire extending between respective wire attach components is less than 5 mm. Optionally, the length of the at least one SMA wire extending between respective wire attach components is less than 4 mm or less than 3 mm.

Such short SMA wires provide a high spring constant and thus allow the actuator assembly to have high resonant frequencies. This is beneficial for actuator assemblies that require to be operated with low transition times as the drive frequency does not excite the resonance (discussed in more detail below). Having such short SMA wires also reduces the power required to heat the SMA wires for actuation (discussed in more detail below) and allows the actuator assembly to be very small.

This makes the actuator assembly suitable for applications where the movable element is desired to be moved with relatively short stroke, but with a movement cycle in which the movable element is moved relatively rapidly and then held in position. Non-limitative examples of such applications include super-resolution cameras, 3D sensing systems and wobulation of a displayed (e.g. projected) image. One application is a super-resolution camera implemented in a laptop computer, in which space is particularly limited.

Optionally, the extent of the actuator assembly along an axis parallel or substantially parallel to the at least one SMA wire is less than 6.5 mm.

Optionally, the length of the at least one SMA wire extending between respective wire attach components is less than 4 mm. And, optionally, the extent of the actuator assembly along an axis parallel or substantially parallel to the at least one SMA wire is less than 5.5 mm.

Optionally, the length of the at least one SMA wire extending between respective wire attach components is less than 3 mm. And, optionally, the extent of the actuator assembly along an axis parallel or substantially parallel to the at least one SMA wire is less than 4.5 mm.

Optionally, the extent of the actuator assembly (excluding any component(s) on which the control circuit is implemented) along an axis parallel or substantially parallel to the at least one SMA wire is less than 6.5 mm, optionally less than 5.5 mm or optionally less than 4.5 mm.

As previously mentioned, the actuator assembly may be very small. For example, the maximum extent of the actuator assembly along an axis parallel or substantially parallel to the SMA wire may be less than 6.5 mm (for example, when the maximum length of the SMA wire extending between the wire attach components is less than 5 mm), less than 5.5 mm (for example, when maximum length of the SMA wire extending between the wire attach components is less than 4 mm) or less than 4.5 mm (for example, when the maximum length of the SMA wire extending between the wire attach components is less than 3 mm). In other words, the length of the at least one SMA wire extending between the wire attach components may be more than 66% and less than 77% of the extent of the actuator assembly along an axis parallel or substantially parallel to the at least one SMA wire. Optionally, the length of the at least one SMA wire extending between the wire attach components may be more than 66% and less than 77% of the extent of the actuator assembly (not including any component(s) on which the control circuit is implemented) along an axis parallel or substantially parallel to the at least one SMA wire.

Optionally, the actuator assembly comprises a heat sink arranged adjacent to the at least one SMA wire such that the thermal environment along a major portion of the at least one SMA wire is substantially uniform.

Optionally, the movable part is arranged to move with respect to the support structure across a range of movement in two orthogonal directions perpendicular to a primary axis extending through the movable part and the at least one SMA wire comprises plural SMA wires.

Optionally in one type of actuator assembly, a suspension system is provided that supports the movable part on the support structure and is arranged to guide movement of the movable part with respect to the support structure in said two orthogonal directions perpendicular to a primary axis extending through the movable part.

Optionally, the suspension system comprises at least one flexure extending between the support structure and the movable part.

Optionally, the movable part has four sides with corners therebetween, the at least one flexure comprises a total of two flexures, the flexures being bent around opposite corners and comprising two legs extending along first portions of a respective pair of the sides of the movable part, and the plural SMA wires comprises a total of four SMA wires, the four SMA wires each extending along second portions of a respective side of the movable part beyond the first portions. This arrangement takes advantage of the short length of the SMA wires to position the legs of the flexures and the SMA wires on different portions of each side of the movable part, thereby making the actuator assembly more compact.

Optionally, the suspension system comprises (or consists of) at least one piece of resilient material arranged between the support structure and the movable part in a direction parallel to the primary axis and connected to the support structure and the movable part. The use of resilient material between the support structure and the movable part provides a relatively high stiffness in the orthogonal directions perpendicular to a primary axis, thereby advantageously increasing the resonant frequency while reducing the stroke.

Optionally, the at least one piece of resilient material comprises plural pieces of resilient material. Providing plural pieces of resilient material allows them to be distributed in a manner providing the suspension system with good stability.

Optionally in another type of actuator assembly, only the plural SMA wires support the movable part on the support structure.

Optionally, the plural SMA wires comprise a total of three or more (e.g. four) SMA wires disposed around the movable part extending outwardly from the movable part, for example extending along axes that intersect at a common point.

Optionally, the at least one shape memory alloy (SMA) wire is connected between the support structure and the movable part via a mechanism configured such that a change in the length of the SMA wire produces a smaller change in the position of the movable part. This can make the actuator assembly even more suitable for the aforementioned ‘short stroke’ applications. With such a mechanism, the actuator assembly may have similar advantages even if the length of the at least one SMA wire extending between respective wire attach components is more than 5 mm (e.g. up 10 mm).

Optionally, the at least one shape memory alloy (SMA) wire is connected between the support structure and the movable part via a mechanism configured such that a change in the length of the SMA wire produces a greater change in the position of the movable part. This may overcome limitations in the stroke of the wire. Additionally, using a shorter wire may reduce the power-consumption of the actuator assembly.

The actuator assembly may comprise a total of four SMA wires connected between the support structure and the movable part via wire attach components. Optionally, the movable part is arranged to move across a range of movement in two orthogonal directions perpendicular to a primary axis extending through the movable part; and none of the SMA wires are capable of being selectively driven to move the movable part relative to the support structure to any position in said range of movement without applying any net torque to the movable part in the plane of the two orthogonal directions around the primary axis.

Optionally, the movable part is arranged to move along a primary axis extending through the movable part.

Optionally, the actuator assembly comprises a helical bearing arrangement supporting the movable part on the support structure and arranged to guide helical movement of the movable part with respect to the support structure around a primary axis; and the at least one SMA wire is connected between the support structure and the movable part in, or at an acute angle to, a plane normal to the primary axis and arranged, on contraction, to drive rotation of the movable part around the primary axis which the helical bearing arrangement converts into said helical movement.

Optionally, the actuator assembly comprises eight SMA wires, divided in two groups of four SMA wires. Two SMA wires are located on each of four sides around a primary axis, the four sides extending in a loop around said primary axis. The two SMA wires on each of the four sides are inclined with respect to said primary axis. The SMA wires of each of the two groups of four SMA wires are arranged with a 2-fold rotational symmetry about the primary axis. The SMA wires are connected between the movable part and the support structure so that one of the two groups of four SMA wires provides a force on the movable part with a component in a first direction along the primary axis and the other of the two groups of four SMA wires provides a force on the movable part with a component in a second direction along the primary axis, opposite to the first direction.

Optionally, the actuator assembly comprises a suspension system that supports the movable part on the support structure and is arranged to guide movement of the movable part with respect to the support structure along a primary axis and to constrain movement of the movable part with respect to the support structure along axes perpendicular to the primary axis; and two SMA wires each connected at one end to the support structure and at the other end to the movable part arranged to apply respective forces to the movable part with respective components parallel to the primary axis that are in opposite directions, the two SMA wire being inclined at a first acute angle greater than 0 degrees with respect to a plane normal to the primary axis, and being parallel, or being inclined from parallel by a second acute angle as projected on the plane normal to the primary axis, the two SMA wires applying a couple to the movable part perpendicular to the primary axis and the suspension system being arranged to resist the couple applied to the movable part by the two SMA wire.

Optionally, the movable part comprises an optical component (such as a lens assembly comprising a lens or a plurality of lenses, a mirror, beam spreader/beam splitter, a diffractive optical element, a filter, a prism, a reflective optical element, a polarising optical element, a dielectric mirror, spatial light modulator, patterned plate, grid and/or a metallic mirror). Where this is the case, the above-mentioned primary axis may be the optical axis of the optical component.

Alternatively or additionally, the movable part may comprise a light source. The light source may otherwise be referred to as an emitter and is configured to emit radiation (visible light or non-visible radiation, e.g. near infrared (NIR) light, short-wave infrared (SWIR) light). The light source or emitter may comprise one or more LEDs or lasers, for example VCSELs (vertical-cavity surface-emitting lasers) or edge-emitting lasers. The emitter may comprise a VCSEL array. The emitter may otherwise be referred to as an illumination source or a light source and/or may comprise an image projector.

Optionally, the movable part comprises display (for displaying an image) or a part thereof. The display may be a display panel for displaying an image, for example a LCOS (liquid crystal on silicon) display, a MicroLED display, a digital micromirror device (DMD) or a laser beam scanning (LBS) system.

Optionally, the movable part comprises an image sensor, a display, an emitter or a part thereof.

As described above, the actuator assembly may comprise a control circuit configured to apply drive signals to the at least one SMA wire so as to drive movement of the movable part relative to the support structure between predetermined positions in a repeated pattern.

Optionally, the control circuit is configured to apply the drive signals to the at least one SMA wire for the purpose of achieving super-resolution imaging or wobulation.

The predetermined positions in the repeated pattern may be at least two positions. So, the movable part may repeatedly move between two predetermined positions. The predetermined positions in the repeated pattern may be four (or more) positions. For example, the control circuit may be configured to apply drive signals to the at least one SMA wire so as to drive movement of the movable part relative to the support structure between a total of four predetermined positions in a repeated pattern

Optionally, the predetermined positions in the repeated pattern may be arranged in two degrees of freedom. The predetermined positions may form a square, for example. In general, the predetermined positions may form a triangle, pentagon, hexagon, or any other regular shape. The predetermined positions may be positioned along a loop, for example an elliptical (e.g. circular) path.

The predetermined positions may be stationary positions, so the movable part may stop at each of the predetermined positions before moving on to the next of the predetermined positions. Alternatively, the movable part may move continuously between the predetermined positions, for example along a predetermined continuous path.

The control circuit may be configured to apply the drive signals to the at least one SMA wire for the purpose of achieving super-resolution imaging. In the case that the movable part comprises a lens and/or an image sensor, the control circuit may drive movement of the movable part between predetermined positions in a repeated pattern, which in turn moves the image on the image sensor between predetermined image positions in the repeated pattern. The image on the image sensor may, for example, move by a sub-pixel distance between the predetermined image positions. Super-resolution imaging may then be achieved, for example, by combining two or more images that are captured at positions offset from one another by a sub-pixel distance.

For this purpose, the movable part may be controllably moved between predetermined positions that are offset from each other such that the image on the image sensor moves, in a direction parallel to the light-sensitive region of the image sensor, by a sub-pixel distance. Light that falls onto a centre of a pixel at one position (and so may be used to capture an image) thus falls between pixels at another position. The control circuit may drive the at least one SMA wire so as to controllably move the movable part in this manner. A sub-pixel distance is a distance that is less than a pixel pitch of the light-sensitive region of the image sensor. The pixel pitch refers to the distance between the centres of two adjacent pixels.

The movable part may be controllably moved such that the image on the image sensor moves to a positional accuracy of 0.5 μm or smaller.

The predetermined positions may be offset from one another in a direction along a pixel row and/or along a pixel column of the light-sensitive region of the image sensor. The predetermined positions may comprise i) one or more positions that are offset from a starting position by a sub-pixel distance along a pixel row, and ii) one or more positions that are offset from a starting position by a sub-pixel distance along a pixel column. Optionally, the two or more positions may comprise one or more positions that are offset from a starting position by a sub-pixel distance along a pixel row and along a pixel column.

Images are captured at each of the predetermined positions using the image sensor. A controller may control the image sensor so as to capture the images. The controller may be implemented as part of the control circuit or as part of another circuit. Alternatively, the controller may be implemented as part of the processor that forms part of the portable electronic device.

The images may then be combined so as to form a super-resolution image, for example using the processor of the portable electronic device or the above-described controller. The super-resolution image has a resolution that is greater than the resolution of the individual images that are captured by the image sensor. For example, the two or more images may be combined by interleaving the two or more images.

Wobulation may be achieved in general in a synonymous manner described with reference to super-resolution imaging. Instead of capturing an image with an image sensor at each predetermined position, the movable part may project or display an image at each predetermined position. The image projected or otherwise displayed at each predetermined position may be a lower resolution image formed of a subset of pixels of a high-resolution image. The high-resolution image may thus be effectively split into multiple lower-resolution images that are projected in rapid succession. The movable part may be moved between the predetermined positions in the repeated pattern at a frequency such that the succession of lower-resolution images is perceived by the human eye as one high-resolution image. Such a frequency may be equal to or greater than 30 frames per second, optionally equal to or greater than 60 frames per second, optionally equal to or greater than 120 frames per second.

Optionally, the control circuit is configured to apply drive signals to the at least one SMA wire so as to induce movement of the movable part between the predetermined positions at a predetermined frequency. The predetermined frequency may be greater than 30 Hz, preferably greater than 60 Hz, further preferably greater than 120 Hz.

Optionally, the time spent by the movable part at each of the predetermined position may be the same or may be different. For example, the movable part may comprise an electronic component (such as an image sensor, display or light source) and this electronic component may indicate when the movable part should be moved to the next position. Specifically, the electronic component may send a signal to the control circuit, which in turn applies one or more drive signals to the at least one SMA wire so as to induce movement of the movable part relative to the support structure to another of the predetermined positions.

According to a second aspect of the present invention, there is provided an actuator assembly comprising: a support structure; a movable part movable relative to the support structure; at least one shape memory alloy (SMA) wire connected between the support structure and the movable part via wire attach components and arranged, on contraction, to drive movement of the movable part, further including any of the optional features in accordance with the first aspect of the present invention that are discussed above.

According to a third aspect of the present invention, there is provided an actuator assembly comprising: a support structure; a movable part movable relative to the support structure; and at least one shape memory alloy (SMA) wire connected between the support structure and the movable part via wire attach components and arranged, on contraction, to drive movement of the movable part, wherein the length of the at least one SMA wire extending between respective wire attach components is less than 5 mm, preferably less than 4 mm, more preferably less than 3 mm.

### BRIEF DESCRIPTION OF THE DRAWINGS

Certain embodiments of the present invention will now be described, by way of example only, with reference to the accompanying drawings, in which:

FIG. 1 is a schematic side view of an actuator assembly;

FIG. 2 is a plan view of a first arrangement of the actuator assembly;

FIG. 3 is a side view of a modification of the first arrangement of the actuator assembly illustrating an alternative suspension system;

FIG. 4 is a plan view of a second arrangement of the actuator assembly;

FIG. 5 is a plan view of a third arrangement of the actuator assembly;

FIG. 6A is a schematic plan view of a fourth arrangement of the actuator assembly;

FIG. 6B is an enlarged view of certain elements of the actuator assembly of FIG. 6A; and

FIGS. 7A-D are schematic diagrams illustrating a particular method of achieving super-resolution imaging or wobulation.

### DETAILED DESCRIPTION

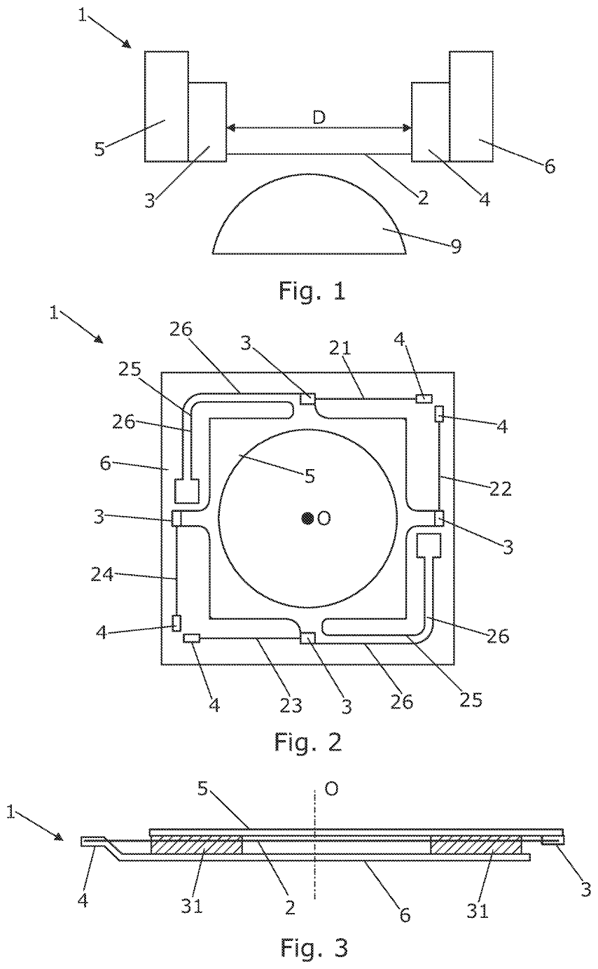

FIG. 1 schematically shows an actuator assembly 1 comprising a shape memory alloy (SMA) actuator wire 2 connected between two crimps 3 and 4. Crimp 3 forms part of a movable part 5 and crimp 4 forms part of a support structure 6. The movable part 5 is arranged to be movable relative to the support structure 6 by any suitable means as known in the art, some examples of which are described below.

The SMA wire 2 is connected at one end to the movable part 5 by the crimp 3 and at the other end to the support structure 6 by the crimp 4. The crimps 3 and 4 hold the wire mechanically, optionally strengthened by the use of adhesive. The crimps 3 and 4 also provide an electrical connection the SMA wire 2. Instead of crimps 3 and 4, any other suitable wire attach components for connecting the SMA wire 2 may alternatively be used, e.g. welds are suitable wire attach components.

SMA material has the property that on heating it undergoes a solid-state phase change which causes the SMA material to contract. At low temperatures, the SMA material enters the Martensite phase. At high temperatures the SMA enters the Austenite phase which induces a deformation causing the SMA material to contract. The phase change occurs over a range of temperature due to the statistical spread of transition temperature in the SMA crystal structure. Thus heating of the SMA wire 2 causes it to decrease in length. The SMA actuator wire 2 may be made of any suitable SMA material, for example Nitinol or another Titanium-alloy SMA material. Advantageously, the material composition and pre-treatment of the SMA wire 2 is chosen to provide phase change over a range of temperature that is above the expected ambient temperature during normal operation and as wide as possible to maximise the degree of positional control.

On heating the SMA wire 2 (by providing an electrical drive current through the SMA wire and generating heat from resistive heating), the stress therein increases and it contracts. This causes movement of the movable part relative to the support structure. A range of movement occurs as the temperature of the SMA increases over the range of temperature in which there occurs the transition of the SMA material from the Martensite phase to the Austenite phase.

As a result, the SMA wire 2 is capable of being driven to move the movable part relative to the support structure. The magnitude of the range of movement depends on the geometry and the range of contraction of the SMA actuator wire 2 within their normal operating parameters. By way of non-limitative example, the SMA wire 2 may have a diameter of 25 to 30 μm.

### Short Wire

The length D of the SMA wire 2 extending between the crimps 3 and 4 is less than 5 mm, preferably less than 4 mm, and most preferably less than 3 mm.

The use of such a short SMA actuator wire is surprising as, in currently known applications, they are considered undesirable.

SMA actuator wires used in currently known applications are significantly longer. This is because longer SMA wires are required to provide useful stroke, given that the actuation stroke of an SMA wire is approximately proportional to its length.

Also, longer SMA wires are used because SMA actuator assemblies are often configured to measure the electrical resistance of its SMA wires as a feedback parameter for determining the position of the component being moved by the SMA wires, and using such short SMA wires increases measurement uncertainty due to lower signal-to-noise ratios (given that the measurable electrical resistance in such short SMA wires is much lower).

The applicant has, however, identified new applications where the low stroke provided by such short SMA actuator wires is sufficient, and where the disadvantages of having such a short SMA wire are outweighed by its benefits, i.e. wherein having a small actuator with low power requirement and high transition speed is critical.

Such short SMA wires allow SMA actuator assemblies to have a very small footprint. For example, where the length of the SMA wire 2 extending between the two crimps 3 and 4 is less than 5 mm, less than 4 mm or less than 3 mm, the maximum extent of the actuator assembly 1 along an axis parallel or substantially parallel to that SMA wire 2 may be less than 6.5 mm, less than 5.5 mm and less than 4.5 mm, respectively.

The usage of such short SMA wires also significantly reduces the power required to contract the SMA wires, given that there is less volume of wire to be heated.

Such short SMA wires also allow very low transition times (i.e. very high drive frequency operation) to be achieved effectively (i.e. without exciting resonance of the SMA wire), as shorter SMA actuator wires have higher natural/resonant frequencies. This is because the stiffness (k) of an SMA wire, is proportional to its cross-sectional area (A) and inversely proportional to its length (L):

$$k ∝ \frac{A}{L}$$

And the natural frequency of an SMA wire is proportional to its stiffness (k) and inversely proportional to its mass (m):

$$natural frequency = \frac{1}{2 π} \sqrt{\frac{k}{m}}$$

Thus, for a given cross-sectional area (A), decreasing the length (L) of an SMA actuator wire increases its stiffness (k) and reduces its mass (m), and so increases the natural/resonant frequency of the SMA wire 2.

Thus, when the SMA actuator wire 2 has a length of less than 5 mm, less than 4 mm and less than 3 mm extending between the crimps 3 and 4, the actuator assembly 1 can be effectively operated (i.e. operated without exciting resonance of the SMA wire) with transition times of less than 10 ms, less than 3 ms and less than 1 ms, respectively.

Using such an SMA wire 2 makes the actuator assembly 1 suitable for applications where the movable element is desired to be moved with relatively short stroke, but with a movement cycle in which the movable element is moved relatively rapidly and then held in position, for example in each of a plurality of predetermined positions in a repeated pattern.

Non-limitative examples of such applications include super-resolution cameras, wobulation of an image and 3D sensing systems. In an example of a super-resolution camera, the image sensor (or other optical component) may be moved to change the image capture location by a small amount, for example in some implementations by half a pixel, and performing image capture at each location, so that the captured images may be combined to increase resolution. Such movement is typically much smaller (e.g. 10 times smaller or even 100 times smaller) than when performing other applications such as optical image stabilisation (OIS). Typically the movement may be less than 3 μm (microns), more often less than 1.5 μm, most often less than 1 μm. Typically the movement is relatively quick, for example in some implementations of the order of 1-5 ms, and the movable part 5 is subsequently held, for example in some implementations for 10 s of ms. This is a different movement profile from other applications such as OIS, where the movement is typically continuous with a frequency of, for example, 4-6 Hz peak or higher, with a cycle period of, for example, 200 ms. In the case of wobulation, a display panel, image projector or an optical element is moved.

Wobulation may be achieved in general in a synonymous manner described with reference to super-resolution imaging. Instead of capturing an image with an image sensor at each predetermined position, the projector (for example) may project an image at each predetermined position. The image projected at each predetermined position may be a lower resolution image formed of a subset of pixels of a high-resolution image. The high-resolution image may thus be effectively split into multiple lower-resolution images that are projected in rapid succession. The movable part may be moved between the predetermined positions in the repeated pattern at a frequency of greater than 30 Hz, preferably greater than 60 Hz, further preferably greater than 120 Hz, such that the succession of lower-resolution images is perceived by the human eye as one high-resolution image. Typically the movement may be less than 3 μm (microns), less than 2 μm, or less than 1.5 μm.

In the case of 3D sensing systems, the actuator assembly may be used to move an illumination pattern, specifically a non-uniform projection pattern, e.g. a pattern of dots. For example, the actuator assembly may be used to scan a projected pattern of dots. Such a pattern may be used in time-of-flight methods (in which a time-of-flight sensor is used to determine the time-of-flight to each of a series of dots in order to build up a 3D picture of a scene) or in structured light methods (in which the distortion of a light pattern is used to determine a 3D map of a scene), for example. In the latter case an infra-red sensor or an event camera may be used, for example. In 3D sensing applications the movable part may comprise an optical element (e.g. a lens, beam splitter, spatial light modulator, patterned plate, a grid or a diffraction grating) or a light source (or part of a light source).

### Heat Sink

After actuation of the SMA wire 2, the SMA wire 2 may be cooled by reducing or ceasing the drive current to allow the SMA wire 2 to cool by conduction, convection, and radiation to its surroundings.

As shown in FIG. 1, the actuator assembly 1 may be provided with a heat sink 9 arranged adjacent to the SMA wire 2. The heat sink 9 is optional, but when provided ensures that the thermal environment along a major portion of the SMA wire 30 is substantially uniform.

The major portion of the SMA wire 2 comprises at least 50% of the SMA wire. Preferably, the major portion of the SMA wire 2 comprises at last 75% of the SMA wire. Further preferably, the major portion of the SMA wire 2 comprises at least 90% of the SMA wire 2. The larger the portion of the SMA wire 2 along which the thermal environment is substantially uniform, the easier it is to accurately control the length of the SMA wire 2. Furthermore, the risk of damage to the SMA wire 2 is reduced.

The thermal environment may be substantially uniform in the sense that it varies by less than 10%, preferably less than 5%. This means, that the heat transfer from the SMA wire 30 to the heat sink 9 is substantially uniform (varying by less than 10%, preferably less than 5%) along the major portion of the SMA wire 2. The heat sink may be arranged in a number of ways to achieve such a substantially uniform thermal environment.

The SMA wire 2 and the heat sink 9 may be separated by a gap. So, the SMA wire 2 and the heat sink 9 may not be in direct contact with one another, at least in a middle portion of the SMA wire 2 (i.e. away from the connection portions of the SMA wire 2).

The heat sink 9 may comprise an edge that runs substantially parallel to the SMA wire 2. The minimum distance between the heat sink 9 and the major portion of the SMA wire 2 may be substantially constant. For example, minimum distance between the heat sink 9 and the major portion of the SMA wire 2 may vary by less than 10%, preferably less than 5%. The heat transfer from the SMA wire 2 to the heat sink 9 may depend primarily on the distance between SMA wire 2 and heat sink 9, for example when the heat sink 9 is entirely made from the same material and dominates the heat transfer away from the SMA wire 2. The heat sink 9 may be entirely made from a single material, making manufacture of the heat sink 9 simpler. However, in some embodiments the heat sink 9 may comprise portions of different material, with different distances between such portions of the heat sink and the SMA wire 2.

The distance between the SMA wire 2 and the heat sink 9 determines the rate of heat transfer from the SMA wire 2 to the heat sink 9, i.e. the cooling rate of the SMA wire 2. Depending on the use of the SMA actuator assembly, or exact design parameters of the SMA actuator assembly, it may be desirable to provide a relatively large cooling rate of the SMA wire 2 or a relatively small cooling rate of the SMA wire 2. Providing a larger cooling rate may allow for more rapid expansion after heating of the SMA wire 2 ceases, and so can lead to quicker response times. Providing a smaller cooling rate may allow for the SMA wire 2 to reach higher temperatures during heating, and so may increase the stroke of the SMA wire 2 or decrease the power requirement for heating the SMA wire 2.

The minimum distance (or shortest distance) between the heat sink 9 and the major portion of SMA wire 2 may be at least 25 μm. This may be a minimum distance required to avoid accidental contact between the SMA wire 2 and the heat sink 9. Preferably, the minimum distance between the heat sink 9 and the major portion of SMA wire 2 may be at least 75 μm, further preferably at least 150 μm. This can further reduce the risk of accidental contact between the SMA wire 2 and the heat sink 9. Such a minimum distance may also limit the maximum cooling rate, and thus improve the stroke of the SMA wire 2.

The minimum distance between the heat sink 9 and the major portion of SMA wire 2 may be less than 3 mm. Preferably, the minimum distance between the heat sink 9 and the major portion of SMA wire 2 is less than 2 mm, further preferably less than 1 mm or less than 700 μm. In some embodiments, the minimum distance between the heat sink 9 and the major portion of SMA wire 2 is less than 500 μm or less than 300 μm. An upper limit on the minimum distance between the heat sink 9 and the major portion of SMA wire 2 may ensure that the cooling rate remains relatively high, so as to improve the response time of actuating the SMA wire 2.

The heat sink 9 may be arranged closer to the major portion of the SMA wire 2 than any other component of the SMA actuator assembly (not necessarily including the crimps 3 and 4). So, heat transfer from the SMA wire 2 may be dominated by the presence of the heat sink 9.

Shorter SMA wires may have a more non-uniform thermal environment than long SMA wires, in the absence of a heat sink 9. So, the provision of the heat sink 9 may be particularly advantageous in combination with the above-mentioned short SMA wires 2 (i.e. SMA wires with a length of less than 5 mm, 4 mm, or 3 mm extending between respective wire attach components).

The heat sink 9 may be fixed relative to the support structure and/or relative to the movable part. The heat sink 9 may be integrally formed with the support structure and/or the movable part, or a portion of the support structure and/or the movable part. This may make manufacture of the heat sink 9 simpler, because no separate step of providing the heat sink is required. For example, the heat sink 9 may be made from the same material as the support structure and/or the movable part. Alternatively, the heat sink 9 may be provided separately from the support structure and/or the movable part, and fixed to the support structure and/or the movable part during assembly of the SMA actuator assembly 1. This may allow the heat sink 9 to be made from different materials and may enable more targeted tailoring of the properties of the heat sink 9.

The heat sink 9 may be formed from a metal, such as a steel. A metal may be particularly suitable due to its high thermal conductivity. In general, any other materials, especially those with relatively high thermal conductance (e.g. >1 W/m K, preferably >10 W/m K,), may be suitable to form the heat sink 9. The heat sink 9 may be integrally formed with one of the crimps 3, 4, for example. The crimps 3, 4 may be crimps formed from sheet metal, which material may be especially suitable as a heat sink 9.

As shown in FIG. 1, the heat sink 9 may be shaped to compensate for heat transfer through the crimps 3, 4. Specifically, designing the heat sink 9 so as to provide a relatively higher rate of heat transfer in the middle of the SMA wire 2 and a relatively lower rate of heat transfer at the ends of the SMA wire 2 (where heat transfer through the crimps 3 and 4 is higher) may improve the uniformity of the temperature distribution along the SMA wire 2. The heat sink 9 may be shaped such that the minimum distance between the heat sink 9 the SMA wire 2 increases towards the ends of the SMA wire 2. So, the heat sink 9 tapers away from the SMA wire 2 towards the ends of the SMA wire 2. The minimum distance between the heat sink 9 and a middle section of the SMA wire 2 may be substantially constant.

Alternatively, parameters other than the distance between heat sink 9 and SMA wire 2 may be varied along the SMA wire 2, so as to compensate for heat transfer through the crimps 3 and 4. For example, the heat sink 9 may comprise different materials along the SMA wire 2, in particular a material with relatively high thermal conductivity adjacent to a middle portion of the SMA wire 2 and a material with a relatively low thermal conductivity adjacent improve the middle of the SMA wire 2. In general, the heat sink 9 may be configured such that the thermal heat transfer from the SMA wire 2 to the heat sink 9 decreases towards the ends of the SMA wire 2. This, in combination with heat conduction through the crimps 3 and 4, may improve the overall uniformity of the thermal environment along the SMA wire.

### Possible Arrangements

Such short SMA wires (i.e. SMA wires with a length of less than 5 mm, 4 mm, or 3 mm extending between respective wire attach components) can be used in any SMA actuator assembly comprising a support structure, a movable part movable relative to the support structure, at least one SMA wire connected between the support structure and the movable part via wire attach components and arranged, on contraction, to drive movement of the movable part; where suitable (i.e. where the low stroke provided by such a short SMA wire is suitable). Some examples of possible arrangements for the actuator assembly 1 will now be described. In the following arrangements, the above description applies to like components, such as the SMA wires, so for brevity will not be repeated. In the following arrangements, the movable part 5 may be an optical component, for example a lens arrangement or a light source, in which case the primary axis O may be the optical axis of the optical component. The movable part 5 may be an image sensor, in which case the primary axis O may be the optical axis of a lens arrangement configured to focus light onto the image sensor. The movable part 5 may be an emitter, in which case the primary axis O may be aligned with (e.g. parallel to or coincident with) a general direction in which radiation is emitted by the emitter. The emitter may define a plane and the primary axis may be perpendicular to the plane defined by the emitter. For example, the emitter may comprise a VCSEL array and the primary axis may be perpendicular to the plane defined by the VCSEL array. The movable part 5 may be a display, in which case the primary axis may be aligned with (e.g. parallel to or coincident with) a general direction in which light is emitted from the display. The display may define a plane and the primary axis may be perpendicular to the plane defined by the display.

FIG. 2 shows a first arrangement of the actuator assembly 1 in which the movable part 5 is arranged to move with respect to the support structure 6 across a range of movement in two orthogonal directions perpendicular to the primary axis O extending through the movable part 5.

This movement is achieved by the movable part 5 being supported on the support structure 6 by a suspension system comprising a total of two flexures 25 which extend between the movable part 6 and support structure 6. As described, for example, in WO2014/083318 and WO2017/055788, the suspension system also includes bearings (not shown), e.g. ball bearings or plain bearings, between the movable part 5 and the support structure 6 so as to guide the movement of the movable part 5 with respect to the support structure 6 in said two orthogonal directions. The flexures 25 help guide this movement by biasing the bearings (resisting movement along the primary axis O). The flexures 25 may also be used to form electrical connections to the SMA wires 21 to 24 via the crimps 3 on the movable part 5.

The specific arrangement of the flexures 25 is as follows. The movable part 5 has four sides with corners therebetween, and the flexures 25 are bent around opposite corners. Thus, the flexures 25 each comprise two legs 26 extending along a respective pair of the sides of the movable part 5. However, rather than extending along the entire side of the movable part 5, each leg 26 extends along a first portion of the side of the movable part 5.

To drive the movement of the movable part 5, the actuator assembly 1 comprises a total of four SMA wires 21 to 24, each connected at one end to the movable part 5 by a crimp 3 and at the other end to the support structure 6 by a crimp 4. The four SMA wires 21 to 24 each extend along a respective side of the movable part 5. However, rather than extending along the entire side of the movable part 5, each SMA wire 21 to 24 extends along second portions of the respective side of the movable part 5 beyond the first portions along which the legs 26 of the flexures 25 extend. This arrangement takes advantage of the short length of the SMA wires 21 to 24 to position the legs 26 of the flexures 25 and the SMA wires 21 to 24 on different portions of each side of the movable part 5, thereby making the actuator assembly 1 more compact overall.

In this first arrangement, the SMA actuator wires 21 to 24 each extend perpendicular to the primary axis O. The SMA actuator wires 21 to 24 extend in a common plane perpendicular to the primary axis O which is advantageous in minimising the size of the actuator assembly 1 along the primary axis O.

Each of the SMA actuator wires 21 to 24 is arranged along one side of the movable part 5. Thus, the SMA actuator wires 21 to 24 are arranged in a loop at different angular positions around the axis O. Thus, the four SMA actuator wires 21 to 24 consist of a first pair of SMA actuator wires 21 and 23 arranged on opposite sides of the axis O and a second pair of SMA actuator wires 22 and 24 arranged on opposite sides of the axis O. The first pair of SMA actuator wires 21 and 23 are capable on selective driving to move the movable part relative to the support structure in a first direction in said plane, and the second pair of SMA actuator wires 22 and 24 are capable on selective driving to move the movable part relative to the support structure in a second direction in said plane transverse to the first direction. Movement in directions other than parallel to the SMA actuator wires 21 to 24 may be driven by a combination of actuation of these pairs of the SMA actuator wires 21 to 24 to provide a linear combination of movement in the transverse directions. Another way to view this movement is that simultaneous contraction of any pair of the SMA actuator wires 21 to 24 that are adjacent each other in the loop will drive movement of the movable part in a direction bisecting those two of the SMA actuator wires 21 to 24.

As a result, the SMA actuator wires 21 to 24 are capable of being selectively driven to move the movable part relative to the support structure to any position in a range of movement in two orthogonal directions perpendicular to the axis O. The magnitude of the range of movement depends on the geometry and the range of contraction of the SMA actuator wires 21 to 24 within their normal operating parameters.

The position of the movable part relative to the support structure perpendicular to the axis O is controlled by selectively varying the temperature of the SMA actuator wires 21 to 24. This is achieved by passing through SMA actuator wires 21 to 24 selective drive currents that provides resistive heating. Heating is provided directly by the drive current. Cooling is provided by reducing or ceasing the drive current to allow the SMA wires 21 to 24 to cool by conduction, convection, and radiation to its surroundings.

The short length of the SMA actuator wires 21 to 24 provides the advantages described above, for example reducing the resonant frequency of the actuator assembly 1. The resonant frequency of the actuator assembly 1 may be reduced further by increasing the stiffness of the suspension system. By way of example, FIG. 3 illustrates a modification of the first arrangement of the actuator assembly 1 in which the suspension system formed by the flexures 25 is replaced by an alternative suspension system. Specifically, the suspension system comprises plural pieces of resilient material 31 arranged between the movable part 5 and the support structure 6 in a direction parallel to the primary axis O. The pieces of resilient material 31 are connected to the movable part 5 and the support structure 6 and therefore guide the movement of the movable part 5 with respect to the support structure 6 in said two orthogonal directions. The pieces of resilient material 31 also resist movement along the primary axis O. The resilient material 31 may be, for example, a rubber such as silicone rubber, a polymeric gel or a metal mesh.

Compared to the flexures 25, the pieces of resilient material 31 have a higher stiffness in the orthogonal directions perpendicular to a primary axis O, and thereby advantageously increase the resonant frequency while reducing the stroke.

The number of pieces of resilient material 31 may be varied. In principle a single piece of resilient material 31 could be provided but the use of plural pieces of resilient material 31 allows them to be distributed in a manner providing the suspension system with good stability.

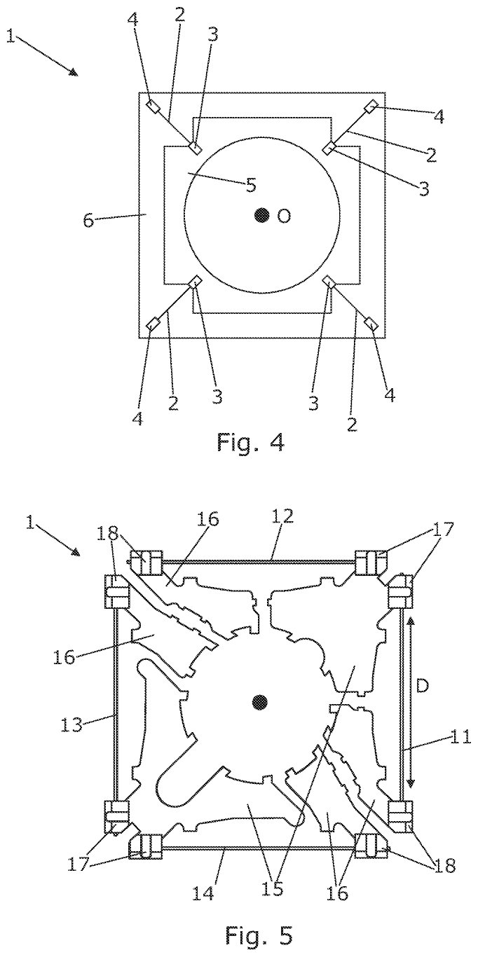

FIG. 4 shows a second arrangement of the actuator assembly 1 in which, like the first arrangement, the movable part 5 is arranged to move with respect to the support structure 6 across a range of movement in two orthogonal directions perpendicular to the primary axis O extending through the movable part 5.

In this arrangement, the actuator assembly 1 comprises a total of four SMA wires 2, each connected at one end to the movable part 5 by a crimp 3 and at the other end to the support structure 6 by a crimp 4. Instead of extending along sides of the movable part 5, the SMA wires 2 are arranged at four corners of the movable part 4 and extend outwardly from the movable part 5. In FIG. 4, the SMA wires 2 may extend along axes that intersect at a common point that lies on the primary axis O, so that the SMA wires on opposite corners are collinear, although the SMA wires 2 may be angular offset from that. The foregoing may be most applicable when the movable part 5 is in a central or ‘zero’ position.

In this second arrangement, the SMA actuator wires 2 each extend perpendicular to the primary axis O. The SMA actuator wires 2 extend in a common plane perpendicular to the primary axis O which is advantageous in minimising the size of the actuator assembly 1 along the primary axis O.

As a result, the SMA actuator wires 2 are capable of being selectively driven to move the movable part 5 relative to the support structure 6 to any position in a range of movement in two orthogonal directions perpendicular to the primary axis O. The magnitude of the range of movement depends on the geometry and the range of contraction of the SMA actuator wires 2 within their normal operating parameters.

The position of the movable part 5 relative to the support structure 6 perpendicular to the axis O is controlled by selectively varying the temperature of the SMA actuator wires 2. This is achieved by passing through SMA actuator wires 2 selective drive currents that provides resistive heating. Heating is provided directly by the drive current. Cooling is provided by reducing or ceasing the drive current to allow the SMA wires 2 to cool by conduction, convection, and radiation to its surroundings.

In the second arrangement, it is possible to support the movable part 5 on the support structure 6 using only the plural SMA wires 2, in which case no suspension system is provided. Alternatively, the actuator assembly 1 may include a suspension system comprising flexures or pieces of resilient material, as in the first arrangement.

FIG. 5 shows a third arrangement of the actuator assembly 1 comprising a total of four SMA wires 11 to 14 (herein also referred to as SMA actuator wires 11 to 14) connected between crimping members 18 formed on support components 16 that form part of a support structure 6, and crimping members 17 formed on movable components 15 that form part of a movable part 5. The SMA wires 11 to 14 correspond to the SMA wire 2 described above.

The support components 16 are connected to each other by other component(s) (not shown) of the support structure 6 such that the support components 16 are fixed relative to each other. The movable components 15 are connected to each other by other component(s) (not shown) of the movable part 6 such that the movable components 15 are fixed relative to each other.

Each of the SMA actuator wires 11 to 14 is held in tension, thereby applying a force between the movable components 15 and the support components 16 in a direction perpendicular to the axis O. In operation, the SMA actuator wires 11 to 14 move the movable part relative to the support structure in two orthogonal directions perpendicular to the primary axis O of the movable part, as described further below.

In this third arrangement, the SMA actuator wires 11 to 14 each extend perpendicular to the axis O. The SMA actuator wires 11 to 14 extend in a common plane perpendicular to the axis O which is advantageous in minimising the size of the actuator assembly 1 along the axis O.

The SMA actuator wires 11 to 14 are connected at one end to the movable components 15 by respective crimping members 17 and at the other end to the support components 16 by crimping members 18. The crimping members 17 and 18 correspond to the crimps 3 and 4 described above. The crimping members 17 and 18 crimp the wire to hold it mechanically, optionally strengthened by the use of adhesive. The crimping members 17 and 18 also provide an electrical connection to the SMA actuator wires 11 to 14. However, any other suitable means for connecting the SMA actuator wires 11 to 14 may alternatively be used (e.g. welds are considered to be suitable wire attach components).

SMA material has the property that on heating it undergoes a solid-state phase change which causes the SMA material to contract. At low temperatures the SMA material enters the Martensite phase. At high temperatures the SMA enters the Austenite phase which induces a deformation causing the SMA material to contract. The phase change occurs over a range of temperature due to the statistical spread of transition temperature in the SMA crystal structure. Thus heating of the SMA actuator wires 11 to 14 causes them to decrease in length. The SMA actuator wires 11 to 14 may be made of any suitable SMA material, for example Nitinol or another Titanium-alloy SMA material. Advantageously, the material composition and pre-treatment of the SMA actuator wires 11 to 14 is chosen to provide phase change over a range of temperature that is above the expected ambient temperature during normal operation and as wide as possible to maximise the degree of positional control.

On heating of one of the SMA actuator wires 11 to 14, the stress therein increases and it contracts. This causes movement of the movable part. A range of movement occurs as the temperature of the SMA increases over the range of temperature in which there occurs the transition of the SMA material from the Martensite phase to the Austenite phase. Conversely, on cooling of one of the SMA actuator wires 11 to 14 so that the stress therein decreases, it expands under the force from opposing ones of the SMA actuator wires 11 to 14. This allows the movable part to move in the opposite direction.

Each of the SMA actuator wires 11 to 14 is arranged along one side of the movable part. Thus, the SMA actuator wires 11 to 14 are arranged in a loop at different angular positions around the axis O. Thus, the four SMA actuator wires 11 to 14 consist of a first pair of SMA actuator wires 11 and 13 arranged on opposite sides of the axis O and a second pair of SMA actuator wires 12 and 14 arranged on opposite sides of the axis O. The first pair of SMA actuator wires 11 and 13 are capable on selective driving to move the movable part relative to the support structure in a first direction in said plane, and the second pair of SMA actuator wires 12 and 14 are capable on selective driving to move the movable part relative to the support structure in a second direction in said plane transverse to the first direction. Movement in directions other than parallel to the SMA actuator wires 11 to 14 may be driven by a combination of actuation of these pairs of the SMA actuator wires 11 to 14 to provide a linear combination of movement in the transverse directions. Another way to view this movement is that simultaneous contraction of any pair of the SMA actuator wires 11 to 14 that are adjacent each other in the loop will drive movement of the movable part in a direction bisecting those two of the SMA actuator wires 11 to 14.

As a result, the SMA actuator wires 11 to 14 are capable of being selectively driven to move the movable part relative to the support structure to any position in a range of movement in two orthogonal directions perpendicular to the axis O. The magnitude of the range of movement depends on the geometry and the range of contraction of the SMA actuator wires 11 to 14 within their normal operating parameters.

The position of the movable part relative to the support structure perpendicular to the axis O is controlled by selectively varying the temperature of the SMA actuator wires 11 to 14. This is achieved by passing through SMA actuator wires 11 to 14 selective drive currents that provides resistive heating. Heating is provided directly by the drive current. Cooling is provided by reducing or ceasing the drive current to allow the SMA wires 11 to 14 to cool by conduction, convection, and radiation to its surroundings.

The arrangement of the SMA actuator wires 11 to 14 along respective sides of the movable part assists in providing a compact arrangement, unlike for example an arrangement in which wires extend radially of the axis O, which would increase the footprint of actuator assembly 1. However as a result of not being radial, each SMA actuator wire 11 to 14 individually applies a torque to the movable part in the plane of the two orthogonal directions around the axis O. However, since none of the wires are collinear, they can be arranged to apply cancelling torques when operated together as described in WO2013/175197. Thus, with this arrangement, movement to any position in the range of movement may in principle be achieved without applying any net torque to the movable part in the plane of the two orthogonal directions around the axis O.

In the third arrangement, it is possible to support the movable part 5 on the support structure 6 using only the plural SMA wires 2, in which case no suspension system is provided. Alternatively, the actuator assembly 1 may include a suspension system comprising flexures (and bearings) or pieces of resilient material, as in the first arrangement.

As mentioned above, SMA actuator wires with a length of less than 5 mm, 4 mm, or 3 mm extending between respective wire attach components can be used in any SMA actuator assembly comprising a support structure, a movable part movable relative to the support structure, at least one SMA wire connected between the support structure and the movable part via wire attach components and arranged, on contraction, to drive movement of the movable part; where suitable (i.e. where the low stroke provided by such a short SMA wire is suitable).

For example, such short SMA wires may be used in the actuator assemblies described in WO2013/175197 which discloses actuator assemblies comprising a total of four SMA wires connected between the support structure and the movable part via respective wire attach components. The movable part is arranged to move across a range of movement in two orthogonal directions perpendicular to a primary axis extending through the movable part. None of the SMA wires are capable of being selectively driven to move the movable part relative to the support structure to any position in said range of movement without applying any net torque to the movable part in the plane of the two orthogonal directions around the primary axis. The movable part may comprise an optical component and the primary axis may be the optical axis of the optical component.

For example, such short SMA wires may be used in the actuator assemblies described in WO2019/243849 which discloses actuator assemblies comprising a helical bearing arrangement supporting the movable part on the support structure and arranged to guide helical movement of the movable part with respect to the support structure around a primary axis. The at least one SMA wire is connected between the support structure and the movable part in, or at an acute angle to, a plane normal to the primary axis and arranged, on contraction, to drive rotation of the movable part around the primary axis. Said rotation is converted into said helical movement by the helical bearing arrangement. The movable part may comprise an optical component and the primary axis may be the optical axis of the optical component.

For example, such short SMA wires may be used in the actuator assemblies described in WO2011/104518 which discloses actuator assemblies comprising eight SMA wires, divided in two groups of four SMA wires. Two SMA wires are located on each of four sides around a primary axis, wherein the four sides extend in a loop around said primary axis. Moreover, the two SMA wires on each of the four sides are inclined with respect to said primary axis, and the SMA wires of each of the two groups of four SMA wires are arranged with a two-fold rotational symmetry about the primary axis. Also, the SMA wires are connected between the movable part and the support structure so that one of the two groups of four SMA wires provides a force on the movable part with a component in a first direction along the primary axis and the other of the two groups of four SMA wires provides a force on the movable part with a component in a second direction along the primary axis, opposite to the first direction. The movable part may comprise an optical component and the primary axis may be the primary axis of the optical component.

For example, such short SMA wires may be used in the actuator assemblies described in WO2019/243842 which discloses actuator assemblies comprising a suspension system that supports the movable part on the support structure. The suspension system is arranged to guide movement of the movable part with respect to the support structure along a primary axis and to constrain movement of the movable part with respect to the support structure along axes perpendicular to the primary axis. Moreover, two SMA wire are each connected at one end to the support structure and at the other end to the movable part arranged to apply respective forces to the movable part with respective components parallel to the primary axis that are in opposite directions. Also, the two SMA wire are inclined at a first acute angle greater than 0 degrees with respect to a plane normal to the primary axis, and are parallel, or are inclined from parallel by a second acute angle as projected on the plane normal to the primary axis. The two SMA wire apply a couple to the movable part perpendicular to the primary axis and the suspension system is arranged to resist the couple applied to the movable part by the two SMA wire. The movable part may comprise an optical component and the primary axis may be the primary axis of the optical component).

These SMA actuator assemblies may also comprise the heat sinks mentioned above in relation to FIG. 1 (e.g. each SMA wire may be provided with an adjacent heat sink).

In many applications, limitation on actuator performance comes from the resonant frequency of the system. In this case another approach that can be applied herein is to modify the actuator assembly 1 to include a force-modifying mechanism (an example of which is described below) configured such that a change in the length of the SMA wire corresponds to a reduced motion of the movable part 5, with the result of gaining precision in the control and increased resonant frequency.

Other limits are imposed by the available slew rate, limited by wire stroke and ability to change the wire temperature. Shorter wires have lower resistance and so are easier to actuate (lower power required), but have to be driven through a larger proportion of their stroke. Therefore another approach that can be applied herein is to modify the actuator assembly 1 to include a force-modifying mechanism (an example of which is described below) such that a change in the length of the SMA wire corresponds to an increased motion of the movable part 5, with the result of gaining velocity of the movable part 5 for a given rate of phase change. Thus, a combination of shorter lengths of SMA wire and force-modifying mechanisms that amplify motion gives flexibility in the design to improve (i.e. reduce) transition times, as well as power consumption.

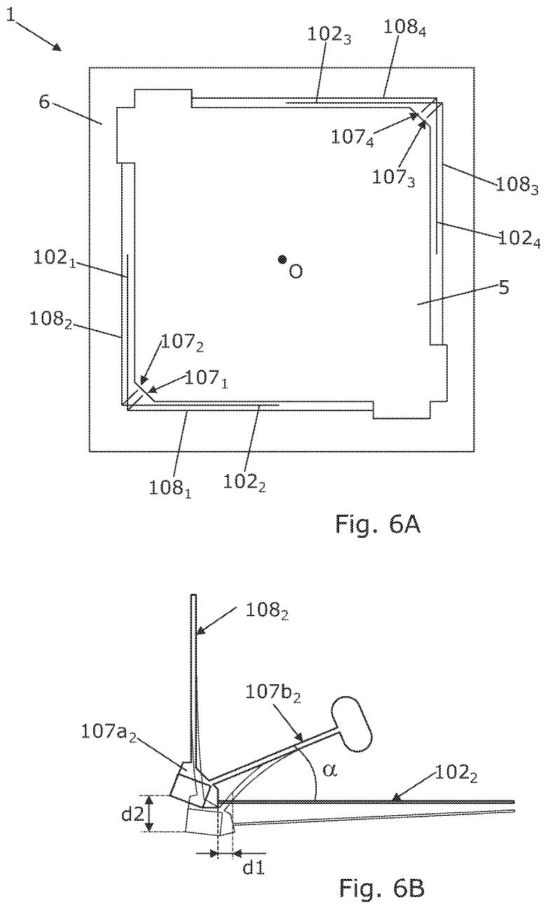

FIG. 6A shows a fourth arrangement of the actuator assembly 1. Again, the movable part 5 may include, for example, a lens arrangement, a light source, or an image sensor and is arranged to move with respect to the support structure 6 across a range of movement in two orthogonal directions perpendicular to the primary axis O. Again, the movable part 5 is supported on the support structure 6 by a suspension system (not shown), which, for example, may be as described above with reference to FIG. 2 or FIG. 3.

To drive the movement of the movable part 5, the actuator assembly 1 comprises a total of four actuating units (denoted by the subscripts 1-4). Each actuating unit includes, firstly, a force-modifying mechanism 107 connected to the support structure 6, secondly, a coupling link 108 connected between the force-modifying mechanism 107 and the movable part 5 and, thirdly, an SMA wire 102 connected (e.g. via crimps) between the support structure 6 and the force-modifying mechanism 107. In use, within each actuating unit, the SMA wire 102 applies an input force on the force-modifying mechanism 107 thereby causing the force-modifying mechanism 107 to apply an output force on the coupling link 108 and causing the coupling link 108 to apply an actuating force on the movable part 5.

Each coupling link 108 extends in a direction that is substantially perpendicular to the direction in which the (related) SMA wire 102 extends. The actuating units are arranged around the edges of the movable part 5 such that the actuating forces are equivalent to the forces produced by the SMA wires 2 in the arrangement of FIG. 2 and as described in WO2013/175197. The actuating units in the same corner of the actuator assembly 1 are shown in FIG. 6A as being offset from each other. However, these actuating units (e.g. the force-modifying mechanisms 107₁, 107₂) may be substantially aligned when viewed along the primary axis O.

Each coupling link 108 is preferably a flexure and is compliant in a direction perpendicular to the direction of its actuating force, although in general the coupling link 108 may comprise any other mechanism capable of applying the actuating force to the movable part 5 and allowing compliance in a direction perpendicular to the actuating force.

As shown more fully in FIG. 6B, each force-modifying mechanism 107 includes, firstly, a connecting portion 107a to which the SMA wire 102 and the coupling link 108 are connected and, secondly, a force-modifying flexure 107b connected between the connecting portion 107a and the support structure 6 and configured to bend in response to the input force. Each force-modifying flexure 107a extends (in the absence of an input force) in a direction that it is at angle α to the direction in which the (related) SMA wire 102 extends. In response to a change in length of an SMA wire 102, the end of the SMA wire 102 that is connected to the force-modifying mechanism 107 moves relative to the support structure 6 by a first distance d1, and the end of the coupling link 108 that is connected to the force-modifying mechanism 107 moves relative to the support structure 6 by a second distance d2. Each force-modifying mechanism 107 can be configured such that the angle α is less than 45° and so the second distance d2 is greater than (e.g. double) the first distance d1. Alternatively, each force-modifying mechanism 107 can be configured such that the angle α is greater than 45° and so the second distance d2 is less than (e.g. half) the first distance d1. Hence, the motion of the movable part 5 can be amplified or de-amplified and the effects described above can be obtained.

### Example of a Model of Repeated Movement for Super-Resolution

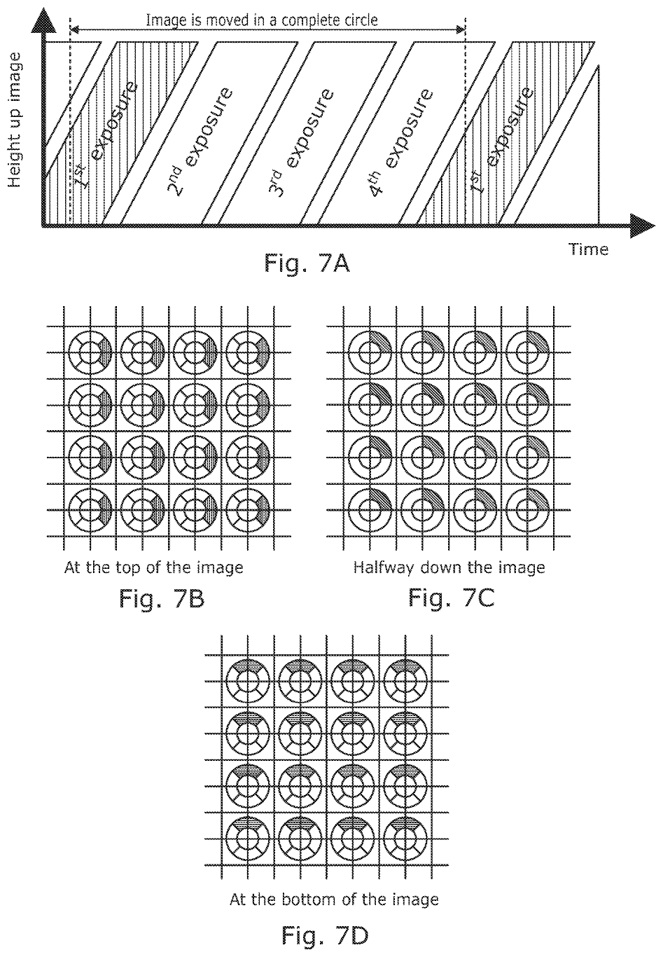

FIGS. 7A-D show an example method of repeated movement enabling super-resolution imaging.

The basic concept of super resolution imaging is that a number of images are captured each with the image offset on the image sensor by a different amount. The images are then combined and the additional information afforded by the additional images is used to create an image of higher resolution (and/or possibly higher quality) than that of the original images.

This simple model assumes that there is a gap between collecting the images and when the image can be moved to a new position. However, if a rolling shutter is used there is often no gap between frames when the image can be moved over the image sensor. This means that using this simple approach a frame needs to be dropped when the image is moved, and this decreases the rate at which images can be collected.

The image may thus be moved relative to the image sensor continuously in a circular manner while four images are collected per cycle. This allows images to be collected for super resolution while a rolling shutter is used.

The image may generally be moved over the image sensor in a continuous manner (motion has a constant speed or velocity) by moving the image sensor, other optical elements or both (e.g. in the camera module described herein).

In the first manifestation the motion is circular and the SMA wires (or other actuator) move the image over the image sensor in a complete circle once every four exposures. This is shown in FIGS. 7A-D. The timing of the actuator motion is locked to the exposures so that at the middle of the image an exposure starts when the image is at the top of the circle. In this case each of the four exposures can be directly equated to one of the super resolution pixels indicated by the grid shown in FIGS. 7A-D. Having the exposures correlated in this manner gives the best quality of image and so is done at the centre of the image.

At the top and the bottom of the image, four independent samples of light are still taken, but they are not arranged in a uniform square grid. This data is converted to a square grid to provide a super resolution image.

The same method can be applied to creating a super-resolution image from images displayed on a display panel or projected by a projector, thus implementing wobulation.

The above-described SMA actuator assemblies comprise an SMA wire. The term ‘shape memory alloy (SMA) wire’ may refer to any element comprising SMA. The SMA wire may have any shape that is suitable for the purposes described herein. The SMA wire may be elongate and may have a round cross section or any other shape cross section. The cross section may vary along the length of the SMA wire. It is also possible that the length of the SMA wire (however defined) may be similar to one or more of its other dimensions. The SMA wire may be pliant or, in other words, flexible. In some examples, when connected in a straight line between two elements, the SMA wire can apply only a tensile force which urges the two elements together. In other examples, the SMA wire may be bent around an element and can apply a force to the element as the SMA wire tends to straighten under tension. The SMA wire may be beam-like or rigid and may be able to apply different (e.g. non-tensile) forces to elements. The SMA wire may or may not include material(s) and/or component(s) that are not SMA. For example, the SMA wire may comprise a core of SMA and a coating of non-SMA material. Unless the context requires otherwise, the term ‘SMA wire’ may refer to any configuration of SMA wire acting as a single actuating element which, for example, can be individually controlled to produce a force on an element. For example, the SMA wire may comprise two or more portions of SMA wire that are arranged mechanically in parallel and/or in series. In some arrangements, the SMA wire may be part of a larger piece of SMA wire. Such a larger piece of SMA wire might comprise two or more parts that are individually controllable, thereby forming two or more SMA wires.

Also disclosed is:

1. An actuator assembly comprising:
a support structure;
a movable part movable relative to the support structure;
at least one shape memory alloy (SMA) wire connected between the support structure and the movable part via wire attach components and arranged, on contraction, to drive movement of the movable part; and
wherein the length of the at least one SMA wire extending between respective wire attach components is less than 5 mm, preferably less than 4 mm, more preferably less than 3 mm.

2. An actuator assembly according to item 1, wherein the extent of the actuator assembly along an axis parallel or substantially parallel to the at least one SMA wire is less than 6.5 mm, preferably less than 5.5 mm, more preferably less than 4.5 mm.

3. An actuator assembly according to item 1 or 2, wherein the length of the at least one SMA wire extending between the wire attach components is more than 66% and less than 77% of the extent of the actuator assembly along an axis parallel or substantially parallel to the at least one SMA wire.

4. An actuator assembly according to any preceding item, comprising a heat sink arranged adjacent to the at least one SMA wire such that the thermal environment along a major portion of the at least one SMA wire is substantially uniform.

5. An actuator assembly according to any preceding item, wherein the movable part is arranged to move with respect to the support structure across a range of movement in two orthogonal directions perpendicular to a primary axis extending through the movable part and the at least one SMA wire comprise plural SMA wires.

6. An actuator assembly according to item 5, further comprising a suspension system that supports the movable part on the support structure and is arranged to guide movement of the movable part with respect to the support structure in said two orthogonal directions perpendicular to a primary axis extending through the movable part.

7. An actuator assembly according to item 6, wherein said suspension system comprises at least one flexure extending between the support structure and the movable part.

8. An actuator assembly according to item 7, wherein the movable part has four sides with corners therebetween, the at least one flexure comprise a total of two flexures, the flexures being bent around opposite corners and comprising two legs extending along first portions of a respective pair of the sides of the movable part, and the plural SMA wires comprise a total of four SMA wires, the four SMA wires each extending along second portions of a respective side of the movable part beyond the first portions.

9. An actuator assembly according to item 6, wherein said suspension system comprises at least one piece of resilient material arranged between the support structure and the movable part in a direction parallel to the primary axis and connected to the support structure and the movable part.

10. An actuator assembly according to item 9, wherein the at least one piece of resilient material comprises plural pieces of resilient material.

11. An actuator assembly according to item 5, wherein only the plural SMA wires support the movable part on the support structure.

12. An actuator assembly according any one of items 1 to 7 or 9 to 11, wherein the plural SMA wires comprise a total of four SMA wires disposed around the movable part extending outwardly from the movable part.

13. An actuator assembly according to item 12, wherein the SMA wires extend along axes that intersect at a common point.

14. An actuator assembly according to any one of item 1 to 13, wherein the at least one shape memory alloy (SMA) wire is connected between the support structure and the movable part via a mechanism configured such that a change in the length of the SMA wire produces a smaller change in the position of the movable part.

15. An actuator assembly according to any one of item 1 to 13, wherein the at least one shape memory alloy (SMA) wire is connected between the support structure and the movable part via a mechanism configured such that a change in the length of the SMA wire produces a greater change in the position of the movable part.

16. An actuator assembly according to any one of items 1 to 11, comprising a total of four SMA wires connected between the support structure and the movable part via respective wire attach components.

17. An actuator assembly according to item 16, wherein the movable part is arranged to move across a range of movement in two orthogonal directions perpendicular to a primary axis extending through the movable part; and
wherein none of the SMA wires are capable of being selectively driven to move the movable part relative to the support structure to any position in said range of movement without applying any net torque to the movable part in the plane of the two orthogonal directions around the primary axis.

18. An actuator assembly according to any of items 1 to 4, wherein the movable part is arranged to move along a primary axis extending through the movable part.

19. An actuator assembly according to any of items 1 to 4 or item 18, comprising a helical bearing arrangement supporting the movable part on the support structure and arranged to guide helical movement of the movable part with respect to the support structure around a primary axis; and wherein the at least one SMA wire is connected between the support structure and the movable part in, or at an acute angle to, a plane normal to the primary axis and arranged, on contraction, to drive rotation of the movable part around the primary axis which the helical bearing arrangement converts into said helical movement.

20. An actuator assembly according to any of items 1 to 4, comprising eight SMA wires, divided in two groups of four SMA wires, wherein:
two SMA wires are located on each of four sides around a primary axis, the four sides extending in a loop around said primary axis;
the two SMA wires on each of the four sides are inclined with respect to said primary axis;
the SMA wires of each of the two groups of four SMA wires are arranged with a 2-fold rotational symmetry about the primary axis;
wherein the SMA wires are connected between the movable part and the support structure so that one of the two groups of four SMA wires provides a force on the movable part with a component in a first direction along the primary axis and the other of the two groups of four SMA wires provides a force on the movable part with a component in a second direction along the primary axis, opposite to the first direction.

21. An actuator assembly according to any of items 1 to 4, comprising a suspension system that supports the movable part on the support structure and is arranged to guide movement of the movable part with respect to the support structure along a primary axis and to constrain movement of the movable part with respect to the support structure along axes perpendicular to the primary axis; and
two SMA wire each connected at one end to the support structure and at the other end to the movable part arranged to apply respective forces to the movable part with respective components parallel to the primary axis that are in opposite directions, the two SMA wire being inclined at a first acute angle greater than 0 degrees with respect to a plane normal to the primary axis, and being parallel, or being inclined from parallel by a second acute angle as projected on the plane normal to the primary axis, the two SMA wire applying a couple to the movable part perpendicular to the primary axis and the suspension system being arranged to resist the couple applied to the movable part by the two SMA wire.

22. An actuator assembly according to any one of the preceding items, wherein the movable part comprises an optical component.

23. An actuator assembly according to item 22 when dependent on any of items 17 to 19, wherein the primary axis is the optical axis of the optical component.

24. An actuator assembly according to any preceding item, wherein the movable part comprises a light source.

25. An actuator assembly according to any one of the preceding items, wherein the movable part comprises an image sensor.

26. An actuator assembly according to any one of the preceding items comprising a control circuit configured to apply drive signals to the at least one SMA wire so as to drive movement of the movable part relative to the support structure between predetermined positions in a repeated pattern.

27. An actuator assembly according to any preceding item, wherein the movable part comprises a display panel for displaying an image.

28. An actuator assembly according to any preceding item, wherein the control circuit is configured to apply the drive signals to the at least one SMA wire for the purpose of achieving super-resolution imaging or wobulation.

29. An actuator assembly according to any preceding item, wherein the predetermined positions in the repeated pattern are arranged in two degrees of freedom.

30. An actuator assembly according to any preceding item wherein the control circuit is configured to apply drive signals to the at least one SMA wire so as to induce movement of the movable part between the predetermined positions at a predetermined frequency.

1. An actuator assembly comprising:
a support structure:
a movable part movable relative to the support structure:
at least one shape memory alloy (SMA) wire connected between the support structure and the movable part via wire attach components and arranged, on contraction, to drive movement of the movable part; and
a control circuit configured to apply drive signals to the at least one SMA wire so as to induce movement of the movable part relative to the support structure between predetermined positions in a repeated pattern,
wherein the length of the at least one SMA wire extending between respective wire attach components is less than 5 mm.

2. An actuator assembly according to claim 1, wherein the extent of the actuator assembly along an axis parallel or substantially parallel to the at least one SMA wire is less than 6.5 mm.

3. An actuator assembly according to claim 1, wherein the length of the at least one SMA wire extending between the wire attach components is more than 66% and less than 77% of the extent of the actuator assembly along an axis parallel or substantially parallel to the at least one SMA wire.

4. An actuator assembly according to claim 1, comprising a heat sink arranged adjacent to the at least one SMA wire such that the thermal environment along a major portion of the at least one SMA wire is substantially uniform.

5. An actuator assembly according to claim 1, wherein:
the movable part is arranged to move with respect to the support structure across a range of movement in two orthogonal directions perpendicular to a primary axis extending through the movable part; and
the at least one SMA wire comprises plural SMA wires.

6. An actuator assembly according to claim 5, further comprising a suspension system that supports the movable part on the support structure and is arranged to guide movement of the movable part with respect to the support structure in said two orthogonal directions perpendicular to a primary axis extending through the movable part.

7. An actuator assembly according to claim 6, wherein said suspension system comprises at least one flexure extending between the support structure and the movable part.

8. (canceled)

9. (canceled)

10. (canceled)

11. An actuator assembly according to claim 5, wherein only the plural SMA wires support the movable part on the support structure.

12. An actuator assembly according to claim 5, wherein the plural SMA wires comprise a total of four SMA wires disposed around the movable part extending outwardly from the movable part.

13. An actuator assembly according to claim 12, wherein the SMA wires extend along axes that intersect at a common point.

14. An actuator assembly according to claim 1, wherein:
the at least one SMA wire is connected between the support structure and the movable part via a mechanism configured such that a change in the length of the SMA wire produces a smaller change in the position of the movable part; or
the at least one SMA wire is connected between the support structure and the movable part via a mechanism configured such that a change in the length of the SMA wire produces a greater change in the position of the movable part.

15. (canceled)

16. An actuator assembly according to claim 1, comprising a total of four SMA wires connected between the support structure and the movable part via respective wire attach components.

17. An actuator assembly according to claim 16, wherein:
the movable part is arranged to move across a range of movement in two orthogonal directions perpendicular to a primary axis extending through the movable part; and
none of the SMA wires are capable of being selectively driven to move the movable part relative to the support structure to any position in said range of movement without applying any net torque to the movable part in the plane of the two orthogonal directions around the primary axis.

18. (canceled)

19. An actuator assembly according to claim 1, comprising a helical bearing arrangement supporting the movable part on the support structure and arranged to guide helical movement of the movable part with respect to the support structure around a primary axis, wherein the at least one SMA wire is connected between the support structure and the movable part in, or at an acute angle to, a plane normal to the primary axis and arranged, on contraction, to drive rotation of the movable part around the primary axis which the helical bearing arrangement converts into said helical movement.

20. (canceled)

21. (canceled)

22. An actuator assembly according to claim 1, wherein:
the movable part comprises an optical component; and
the primary axis is the optical axis of the optical component.

23. (canceled)

24. An actuator assembly according to claim 1, wherein the movable part comprises one or more of: a light source, an image sensor, and a display panel for displaying an image.

25. (canceled)

26. (canceled)

27. An actuator assembly according to claim 1, wherein the control circuit is configured to apply the drive signals to the at least one SMA wire for the purpose of achieving super-resolution imaging or wobulation.

28. An actuator assembly according to claim 1, wherein the predetermined positions in the repeated pattern are arranged in two degrees of freedom.

29. An actuator assembly according to claim 1, wherein the control circuit is configured to apply drive signals to the at least one SMA wire so as to induce movement of the movable part between the predetermined positions at a predetermined frequency.

30. An actuator assembly comprising:
a support structure;
a movable part movable relative to the support structure; and
at least one shape memory alloy (SMA) wire connected between the support structure and the movable part via wire attach components and arranged, on contraction, to drive movement of the movable part;
wherein the length of the at least one SMA wire extending between respective wire attach components is less than 5 mm, preferably less than 4 mm, more preferably less than 3 mm.
